(19) United States
(12) Patent Application Publication
(10) Pub. No.: US 2024/0234835 A1
(43) Pub. Date: Jul. 11, 2024

(54) Cell and Secondary Battery

(71) Applicant: JIANGSU ZENERGY BATTERY TECHNOLOGIES CO., LTD., Suzhou City (CN)

(72) Inventors: Yunhua DENG, Suzhou City (CN); Jiao LIU, Suzhou City (CN); Jinbao ZHU, Suzhou City (CN); Zhexun YU, Suzhou City (CN)

(21) Appl. No.: 18/407,429

(22) Filed: Jan. 8, 2024

(30) Foreign Application Priority Data
Jan. 10, 2023 (CN) 202320062268.2

(51) Int. Cl. H01M 10/42; H01M 4/02; H01M 10/04; H01M 50/46

(52) U.S. Cl. CPC H01M 10/4235; H01M 10/0431; H01M 50/46; H01M 2004/021

(57) ABSTRACT

The disclosure belongs to the technical field of secondary batteries, and in particular, relates to a cell, including: a first separator, a positive electrode plate, a second separator and a negative electrode plate, wherein the first separator, the positive electrode plate, the second separator and the negative electrode plate are stacked in sequence to form a composite electrode plate, and the composite electrode plate is wound to obtain the cell; the cell includes a straight portion and corner portions arranged at two ends of the straight portion, and at least one surface of the positive electrode plate located at the corner portion is provided with a positive electrode buffer coating and/or at least one surface of the negative electrode plate located at the corner portion is provided with a negative electrode buffer coating.

### CROSS-REFERENCE TO RELATED APPLICATION

The disclosure claims the priority to Chinese Patent Application No. 202320062268.2, filed to the Chinese Patent Office on Jan. 10, 2023 and entitled “Cell and Secondary Battery”, which is incorporated in its entirety herein by reference.

### TECHNICAL FIELD

The disclosure belongs to the technical field of secondary batteries, and in particular, relates to a cell and a secondary battery.

### BACKGROUND

A lithium ion battery has advantages such as no pollution, long cycle life, no memory effect, and the like, and has been widely used in portable electronic products such as notebook computers, smart phones, and electric tools. Along with the development of electric vehicles, lithium ion batteries have been widely used in the field of vehicle power batteries.

During the cycle use of the lithium ion battery, the positive and negative electrode materials will expand/contract, in particular, the lattice gaps of a negative electrode graphite material are significantly increased and decreased in processes of lithium intercalation and lithium de-intercalation during charging and discharging, so that the thickness of the negative electrode plate is obviously expanded and contracted; and a binding force generated by expansion of the electrode plate may cause electrode plates in a cell of the lithium ion battery to be compressed mutually and deformed, and wrinkling, black spots and lithium precipitation occur on the negative electrode plate; and in extreme cases, an excessive expansion force may cause the electrode plates to break near the corners, further causing the thickness of the battery to increase and the cycle performance to deteriorate.

In the existing technical solution, a separator coated with a coating is generally used, and the separator coating may increase a gap between electrode plates at corner positions when the cell is hot pressed, thereby reserving a space for expansion of the lithium battery electrode plate. However, in the described solution, firstly, the separator needs a special coating and the process is complex; secondly, the separator coating will increase a lithium ion migration path in an electrolyte, and increase an internal resistance of the battery; moreover, a gap is manufactured by the separator coating, and as the thickness of the separator coating is limited, an upper limit of a gap-forming capability is low, which cannot meet the requirements of a large-capacity battery with a large number of winding turns and a large volume and a novel silicon-based negative electrode battery having large expansion.

Therefore, there is an urgent need for a technical solution to solve the described problems.

### SUMMARY

Some embodiments of the disclosure are: to provide a cell in view of the shortcomings of the related art; in the cell, both a positive electrode plate and a negative electrode plate are provided with buffer coatings, which may provide appropriate spaces for corner portions, so that when the cell expands during a charging and discharging cycle, enough buffer space is provided, thereby avoiding adverse conditions such as compression and deformation, wrinkling, black spots and lithium precipitation and the like caused by the expansion of an electrode plate, and further improving the overall flatness of the cell and prolonging the cycle life of the battery.

In order to achieve the described effect, the disclosure adopts the following technical solution:
a cell, including: a first separator, a positive electrode plate, a second separator and a negative electrode plate, wherein the first separator, the positive electrode plate, the second separator and the negative electrode plate are stacked in sequence to form a composite electrode plate, and the composite electrode plate is wound to obtain the cell; the cell includes a straight portion and corner portions arranged at two ends of the straight portion, and at least one surface of the positive electrode plate located at the corner portion is provided with a positive electrode buffer coating and/or at least one surface of the negative electrode plate located at the corner portion is provided with a negative electrode buffer coating.

In an embodiment mode, the thickness of the positive electrode buffer coating is 5-40 μm, and the thickness of the negative electrode buffer coating is 5-40 μm.

In an embodiment mode, the material of the positive electrode buffer coating is ethylene carbonate, and the material of the negative electrode buffer coating is ethylene carbonate.

In an embodiment mode, the positive electrode buffer coating is distributed in a dotted dispersion manner, and the dotted areal density is 0.1-20 mg/cm²; and the negative electrode buffer coating is distributed in a dotted dispersion manner, and the dotted areal density is 0.1-20 mg/cm².

In an embodiment mode, the positive electrode plate further includes a positive current collector and a positive active coating provided on at least one surface of the positive current collector, the positive electrode buffer coating is provided on at least one surface of the positive active coating, and the compacted density of the positive active coating is 3.0 g/cm³-4.0 g/cm³.

In an embodiment mode, the positive current collector includes a positive electrode uncoated area and a positive electrode coating area, the positive active coating is provided in the positive electrode coating area, the width of the positive electrode uncoated area is 8-15 mm, and the thickness of the positive current collector is 10-30 μm.

In an embodiment mode, the negative electrode plate further includes a negative current collector and a negative active coating provided on at least one surface of the negative current collector, the negative electrode buffer coating is provided on at least one surface of the negative active coating, and the compacted density of the negative active coating is 1.0 g/cm³-1.8 g/cm³.

In an embodiment mode, the negative current collector includes a negative electrode uncoated area and a negative electrode coating area, the negative active coating is provided in the negative electrode coating area, the width of the negative electrode uncoated area is 8-15 mm, and the thickness of the negative current collector is 2-15 μm.

In an embodiment mode, the thickness of the first separator is 10-25 μm, and the thickness of the second separator is 10-25 μm.

In an embodiment mode, the corner radius of a first layer of the cell is r, the corner radius of an (N+1)th layer is kN+r, the length L of the positive electrode buffer coating/the negative electrode buffer coating of the (N+1)th layer is π(kN+r), where k is a length coefficient, and a value range of the length coefficient is 0.31-0.36.

The disclosure provides a secondary battery in view of the shortcomings of the related art, the secondary battery having good cycle life.

The secondary battery includes the cell described above.

Compared with the related art, the beneficial effects of the disclosure lie in that: in the cell of the disclosure, both a positive electrode plate and a negative electrode plate are provided with buffer coatings, which may provide appropriate spaces for corner portions, so that when the cell expands during a charging and discharging cycle, enough buffer space is provided, thereby avoiding adverse conditions such as compression and deformation, wrinkling, black spots and lithium precipitation and the like caused by the expansion of an electrode plate, and further improving the overall flatness of the cell and prolonging the cycle life of the battery.

### BRIEF DESCRIPTION OF THE DRAWINGS

FIG. 1 is a schematic structural diagram of a cell in the disclosure.

FIG. 2 is a schematic structural diagram of a positive electrode plate of the disclosure.

In which: 1. First separator; 2. Positive electrode plate; 21. Positive current collector; 211. Positive electrode uncoated area; 212. Positive electrode coating area; 22. Positive active coating; 23. Positive electrode buffer coating; 3. Second separator; 4. Negative electrode plate; 5. Straight portion; 6. Corner portion.

### DETAILED DESCRIPTION OF THE EMBODIMENTS

For Embodiment, certain terms are used in the description and claims to refer to specific assemblies. A person skilled in the art would understand that hardware manufacturers may refer to the same assembly by using different nouns. The present description and claims do not use differences in names as a manner for distinguishing assemblies, but use differences in functions of assemblies as a criterion for distinguishing. For Embodiment, the term “including” mentioned throughout the description and the claims is an open-ended term and should be interpreted as “including but not limited to”. “Approximately” refers to within an acceptable error range, and a person skilled in the art would have been able to solve the technical problem within a certain error range and substantially achieve the technical effect.

In the illustration of the disclosure, it should be understood that orientation or positional relationships indicated by terms such as “upper”, “lower”, “front”, “rear”, “left”, “right”, and “horizontal”, etc. are orientation or positional relationships based on the accompanying drawings, are only used to facilitate the illustration of the disclosure and to simplify the illustration, rather than indicating or implying that an apparatus or element referred to must have a specific orientation, and be constructed and operated in the specific orientation, and therefore said terms cannot be understood as a limitation to the disclosure.

Hereinafter, the disclosure will be further described in detail in conjunction with the drawings, but the illustration does not serve as a definition to the disclosure.

A cell of the present embodiment includes: a first separator 1, a positive electrode plate 2, a second separator 3 and a negative electrode plate 4, wherein the first separator 1, the positive electrode plate 2, the second separator 3 and the negative electrode plate 4 are stacked in sequence to form a composite electrode plate, and the composite electrode plate is wound to obtain the cell; the cell includes a straight portion 5 and corner portions 6 arranged at two ends of the straight portion 5, and at least one surface of the positive electrode plate 2 located at the corner portion 6 is provided with a positive electrode buffer coating 23 and/or at least one surface of the negative electrode plate 4 located at the corner portion 6 is provided with a negative electrode buffer coating.

In the present disclosure, during winding of an cell, a gap-forming agent is sprayed/coated on two side surfaces at corners of the positive electrode plate 2 and/or the negative electrode plate 4 of the cell, so as to form the positive electrode buffer coating 23 and the negative electrode buffer coating, and preferably a spraying manner is used; the gap-forming agent is sprayed in different operation spaces to face the front face and the back face of the two side surfaces of the positive electrode plate 2 and/or the negative electrode plate 4. The gap-forming agent is an organic solvent, is a transparent and colorless liquid at a temperature above a high temperature (higher than 35° C.), and crystallizes to form a solid at a low temperature (lower than room temperature, i.e. 25° C.). The gap-forming agent is stored at a constant temperature in a spraying device before being sprayed out. In a spraying area of the gap-forming agent, by using cold air at 0-5° C. to blow the surface of the electrode plate, a low-temperature environment of the surface of the electrode plate is ensured, so that the sprayed gap-forming agent may be quickly cooled and solidified. The gap-forming agent is sprayed in a dotted droplet dispersion manner, the spray amount each time is 0.1-100 mg; due to spraying in a dotted dispersion manner, the spraying is small in amount and is sparse, and cold air is blown for quick cooling and solidifying. The number of spraying times of the gap-forming agent on the same area is determined by the required thickness of the gap, and in practical uses, the gap-forming agent is sprayed on the electrode plate for different times, and then the thickness variation value is measured to confirm the thickness of the gap. The gap-forming agent volatilizes during preheating, hot pressing and subsequent baking of the cell, and belongs to a solvent component of an electrolyte, and a small amount of residue does not affect the performance of the battery.

In an embodiment mode, the thickness of the positive electrode buffer coating is 5-40 μm, and the thickness of the negative electrode buffer coating is 5-40 μm. The thicknesses of the positive electrode buffer coatings and the negative electrode buffer coatings in different layers of the cell are different, and the thickness of the positive electrode buffer coating and the negative electrode buffer coating is determined according to different spraying volumes. Setting a certain thickness of the positive electrode buffer coating and a certain thickness of the negative electrode buffer coating makes an interface of the battery flat, and also a corresponding buffer space may be provided, thereby avoiding lithium precipitation and improving the cycle life of the battery.

In an embodiment mode, the material of the positive electrode buffer coating is ethylene carbonate, and the material of the negative electrode buffer coating is ethylene carbonate. The ethylene carbonate is a transparent and colorless liquid at 35° C. or higher, and is a crystallized solid at room temperature, i.e. 25° C.; both the positive electrode buffer coating and the negative electrode buffer coating use an ethylene carbonate solvent, and the ethylene carbonate solvent is stored in a spraying device under a constant temperature at conditions of 35-40° C. before being sprayed out. When spraying is performed, cold air of 0-5° C. is used on the back face of the corner portion 6 of the electrode plate to blow the electrode plate, so as to ensure that the surface of the electrode plate is in a low-temperature environment, and the sprayed ethylene carbonate solvent may be quickly cooled and solidified. The ethylene carbonate solvent is sprayed in a dotted droplet dispersion manner, the spray amount each time is 5-100 mg; due to spraying in a dotted dispersion manner, the spraying is small in amount and is sparse, and cold air is blown for quick cooling and solidifying. The number of spraying times of the ethylene carbonate solvent on the same area is determined by the required thickness of the gap, and in practical uses, the ethylene carbonate solvent may be sprayed on the electrode plate for different times, and then the thickness variation value is measured to confirm the thickness of the buffer coating. The buffer coating volatilizes during preheating, hot pressing and subsequent baking of the cell, and belongs to a solvent component of an electrolyte, and a small amount of residue does not affect the performance of the battery.

In an embodiment mode, the positive electrode plate further includes a positive current collector 21 and a positive active coating provided on at least one surface of the positive current collector 21, the positive electrode buffer coating is provided on at least one surface of the positive active coating, and the compacted density of the positive active coating is 3.0 g/cm³-4.0 g/cm³. If the compacted density of the electrode plate is too large, the expansion of the electrode plate is increased, which easily causes the detachment of the buffer coating; and if the compacted density of the electrode plate is too low, the thickness of the electrode plate is large, which affects the energy density of the battery. Therefore, the positive active coating is provided with a certain compacted density, so that the positive active coating not only protects the electrochemical performance, but also has a firm binding force, and is not easy to fall off at the corner. Specifically, the compacted density of the positive active coating is 3.0 g/cm³, 3.2 g/cm³, 3.4 g/cm³, 3.5 g/cm³, 3.8 g/cm³, and 4.0 g/cm³.

In an embodiment mode, the positive electrode buffer coating is distributed in a dotted dispersion manner, and the dotted areal density is 0.1-20 mg/cm²; and the negative electrode buffer coating is distributed in a dotted dispersion manner, and the dotted areal density is 0.1-20 mg/cm². In an embodiment mode, the dotted areal density in the positive electrode buffer coating is 0.1 mg/cm², 0.8 mg/cm², 1.5 mg/cm², 3 mg/cm², 5 mg/cm², 9 mg/cm², 10 mg/cm², 12 mg/cm², 15 mg/cm², and 20 mg/cm². Preferably, the dotted areal density in the negative electrode buffer coating is 0.1 mg/cm², 0.8 mg/cm², 1.5 mg/cm², 3 mg/cm², 5 mg/cm², 9 mg/cm², 10 mg/cm², 12 mg/cm², 15 mg/cm², and 20 mg/cm². Setting a certain dotted areal density may not only provide a certain gap, but also provide a buffer space, thereby providing flatness and improving the cycle life of a lithium ion battery.

In an embodiment mode, the positive current collector 21 includes a positive electrode uncoated area 211 and a positive electrode coating area, the positive active coating 22 is provided in the positive electrode coating area 212, the width of the positive electrode uncoated area 211 is 8-15 mm, and the thickness of the positive current collector is 10-30 μm. Setting a negative electrode uncoated area of a certain width enables the preparation of a plurality of tabs.

As shown in FIG. 2, setting a positive electrode uncoated area 211 of a certain width enables the preparation of a plurality of tabs. Specifically, the width of the positive electrode uncoated area 211 is 10 mm.

In an embodiment mode, the negative electrode plate further includes a negative current collector and a negative active coating provided on at least one surface of the negative current collector, the negative electrode buffer coating is provided on at least one surface of the negative active coating, and the compacted density of the negative active coating is 1.0 g/cm³-1.8 g/cm³. If the compacted density of the negative electrode plate is too large, the expansion of the electrode plate is increased, which easily causes the detachment of the buffer coating; and if the compacted density of the negative electrode plate is too low, the thickness of the electrode plate is large, which affects the energy density of the battery. Therefore, the negative active coating is provided with a certain compacted density, so that the negative active coating not only protects the electrochemical performance, but also has a firm binding force, and is not easy to fall off at the corner. Specifically, the compacted density of the negative active coating is 1.0 g/cm³, 1.2 g/cm³, 1.4 g/cm³, 1.6 g/cm³, and 1.8 g/cm³.

In an embodiment mode, the negative current collector includes a negative electrode uncoated area and a negative electrode coating area, the negative active coating is provided in the negative electrode coating area, the width of the negative electrode uncoated area is 8-15 mm, and the thickness of the negative current collector is 2-15 μm. Specifically, the width of the negative electrode uncoated area is 8 mm, 10 mm, 12 mm, 13 mm, and 15 mm. Specifically, the thickness of the negative current collector is 2 μm, 4 μm, 6 μm, 8 μm, 10 μm, 12 μm, and 15 μm. Specifically, the width of the negative electrode uncoated area is 10 mm.

In an embodiment mode, the thickness of the first separator is 10-25 μm, and the thickness of the second separator is 10-25 μm. Specifically, the thickness of the first separator is 10 μm, 13 μm, 15 μm, 17 μm, 19 μm, and 20 μm; and the thickness of the second separator is 10 μm, 13 μm, 15 μm, 17 μm, 18 μm, and 19 μm.

In an embodiment mode, the corner radius of a first layer of the cell is r, the corner radius of an (N+1)th layer is kN+r, the length L of the positive electrode buffer coating/the negative electrode buffer coating of the (N+1)th layer is π(kN+r), where k is a length coefficient, and a value range of the length coefficient is 0.31-0.36. According to the winding compact degree of the cell, the length coefficient k takes different values, and then the length L is roughly calculated according to an N-layer buffer coating.

### Embodiment 1

Preparation of positive electrode plate 2:
uniformly mixing lithium cobalt oxide, a conductive agent, i.e. super-conductive carbon (Super-P) and a binder, i.e. polyvinylidene fluoride (PVDF) according to a mass ratio of 97:1.5:1.5 to prepare a positive electrode slurry with a certain viscosity of a lithium ion battery, coating the slurry on a current collector, i.e. an aluminum foil, drying at 85° C. and then performing cold pressing; then performing edge cutting, piece cutting and strip splitting, and after strip splitting, performing drying at 110° C. for 4 hours under a vacuum condition, and a plurality of tabs are die cut and prepared the positive electrode plate 2.

Preparation of negative electrode plate 4:
preparing a slurry by mixing graphite with a conductive agent i.e. super-conductive carbon (Super-P), a thickener i.e. sodium carboxymethyl cellulose (CMC), and a binder i.e. styrene-butadiene rubber (SBR) at a mass ratio of 96:2.0:1.0:1.0, coating the slurry on a current collector, i.e. a copper foil and drying at 85° C.; then performing edge cutting, piece cutting and strip splitting, and after strip splitting, performing drying at 110° C. for 4 hours under a vacuum condition, and a plurality of tabs are die cut and prepared the negative electrode plate 4.

Preparation of electrolyte:
dissolving lithium hexafluorophosphate (LiPF₆) in a mixed solvent composed of ethylene carbonate (EC), dimethyl carbonate (DMC), and ethyl methyl carbonate (EMC) (the mass ratio of the three being 1:2:1), to obtain an electrolyte with a concentration of 1 mol/L.

The first separator 1 is a polypropylene separator, and the second separator 3 is a polypropylene separator.

The first separator 1, the positive electrode plate 2, the second separator 3 and the negative electrode plate 4 are wound to form a cell. The cell includes a straight portion 5 and corner portions 6 arranged at two ends of the straight portion 5; the positive electrode plate 2 is provided with a positive electrode buffer coating 23, and the negative electrode plate 4 is provided with a negative electrode buffer coating; the positive electrode buffer coating 23 is opposite to the corner portion 6, the negative electrode buffer coating is opposite to the corner portion 6, the thickness of the positive electrode buffer coating 23 arranged on both side surfaces of the positive electrode plate 2 located at the corner portion 6 is 5 μm, and the thickness of the negative electrode buffer coating arranged on both side surfaces of the negative electrode plate 4 located at the corner portion 6 is 5 μm.

The cell above and a top cover are connected together by welding, and then placed in a housing made of aluminum with a dimension of 44 mm in a thickness direction; edges of the housing and the top cover are welded and sealed by laser welding, and after drying, an electrolyte is injected through a liquid injection hole, and processes such as negative pressure formation and sealed nail welding are performed, to obtain a prismatic lithium ion battery.

### Embodiment 2

This Embodiment differs from Embodiment 1 in that: the thickness of the positive electrode buffer coating 23 arranged on both side surfaces of the positive electrode plate 2 located at the corner portion 6 is 10 μm, and the thickness of the negative electrode buffer coating arranged on both side surfaces of the negative electrode plate 4 located at the corner portion 6 is 10 μm.

The rest is the same as that in Embodiment 1, and will not be repeated here.

### Embodiment 3

This Embodiment differs from Embodiment 1 in that: the thickness of the positive electrode buffer coating 23 arranged on both side surfaces of the positive electrode plate 2 located at the corner portion 6 is 15 μm, and the thickness of the negative electrode buffer coating arranged on both side surfaces of the negative electrode plate 4 located at the corner portion 6 is 15 μm.

The rest is the same as that in Embodiment 1, and will not be repeated here.

### Embodiment 4

This Embodiment differs from Embodiment 1 in that: the thickness of the positive electrode buffer coating 23 arranged on both side surfaces of the positive electrode plate 2 located at the corner portion 6 is 20 μm, and the thickness of the negative electrode buffer coating arranged on both side surfaces of the negative electrode plate 4 located at the corner portion 6 is 20 μm.

The rest is the same as that in Embodiment 1, and will not be repeated here.

### Comparative Embodiment 1

This Embodiment differs from Embodiment 1 in that: there is no positive electrode buffer coating 23, and there is no negative electrode buffer coating.

The rest is the same as that in Embodiment 1, and will not be repeated here.

### Comparative Embodiment 2

This Embodiment differs from Embodiment 1 in that: the thickness of the positive electrode buffer coating 23 arranged on both side surfaces of the positive electrode plate 2 located at the corner portion 6 is 25 μm, and the thickness of the negative electrode buffer coating arranged on both side surfaces of the negative electrode plate 4 located at the corner portion 6 is 25 μm.

The rest is the same as that in Embodiment 1, and will not be repeated here.

A performance cycle test of secondary batteries obtained by the described preparation was performed, and the results are recorded in Table 1.

Test conditions: under 45° C., performing constant-current charging at 0.5C to 4.35 V, performing constant-voltage charging at 4.35 V to 0.05C current, then performing constant-current discharging at 1C to 2.8 V, recording an initial capacity; repeating the described test steps for a cycle, and recording the number of cycles of a battery capacity decaying to 80% of the initial capacity as the cycle life.

| | Total | Total | | |
|---|---|---|---|---|
| | thickness of | thickness of | Lithium precipitation | |
| Embodiment | positive buffer | negative buffer | and interface | Cycle life/ |
| no. | coating/μm | coating/μm | situation/25° C. 0.5C/1C | cycle |
| Embodiment 1 | 10 | 10 | No lithium precipitation, | 1490 |
| | | | and flat interface | |
| Embodiment 2 | 20 | 20 | No lithium precipitation, | 1950 |
| | | | and flat interface | |
| Embodiment 3 | 30 | 30 | No lithium precipitation, | 2180 |
| | | | and flat interface | |
| Embodiment 4 | 40 | 40 | Slight lithium precipitation, | 1360 |
| | | | and flat interface | |
| Comparative | 0 | 0 | No lithium precipitation, and | 1030 |
| Embodiment 1 | | | deformation, wrinkling and | |
| | | | black spots on interface | |
| Comparative | 50 | 50 | Serious lithium precipitation, | 960 |
| Embodiment 2 | | | and flat interface | |

It may be determined from Table 1 that: compared with the secondary batteries in Comparative Embodiment 1 and Comparative Embodiment 2, the secondary batteries prepared in the present invention have better performance and higher cycle life; and in Embodiment 3, the number of cycles when the capacity is reduced to 80% is 2180 cycles, and there is no lithium precipitation at the interface of the electrode plates, and the interface is flat.

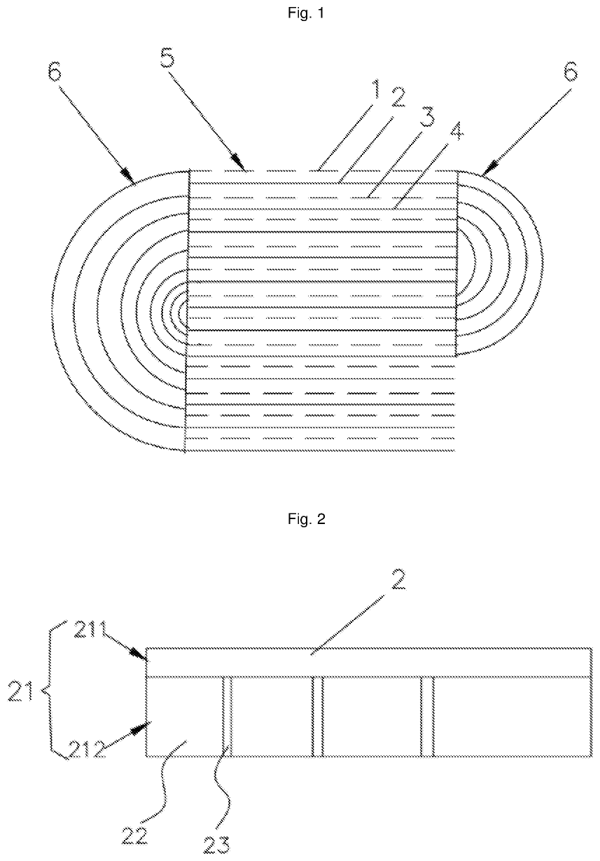

As shown in FIG. 1, the cell in this embodiment includes: a first separator 1, a positive electrode plate 2, a second separator 3 and a negative electrode plate 4, wherein the first separator 1, the positive electrode plate 2, the second separator 3 and the negative electrode plate 4 are stacked in sequence to form a composite electrode plate, and the composite electrode plate is wound to obtain the cell; the cell includes a straight portion 5 and corner portions 6 arranged at two ends of the straight portion 5, and two side surfaces of the positive electrode plate 2 located at the corner portion 6 are provided with positive electrode buffer coatings 23 and/or two side surfaces of the negative electrode plate 4 located at the corner portion 6 are provided with negative electrode buffer coatings.

The positive electrode plate 2 and the negative electrode plate 4 are both provided with buffer coatings on the corner portions 6, thereby effectively avoiding adverse conditions such as compression and deformation, wrinkling, black spots and lithium precipitation and the like caused by the expansion of the electrode plate after a charging and discharging cycle, and further improving the overall flatness of the cell and prolonging the cycle life of the battery. Moreover, the buffer coatings are only provided on the corner portions 6 but not on the straight portion 5, which has little effect on the overall thickness of the cell and does not affect the performance of the battery. Buffer coatings of the same electrode plate are arranged at intervals, the distance of each interval is the length of the straight portion; and the length of the buffer coatings at different layers is gradually increasing; the corner radius of a first layer of the cell is r, the corner radius of an (N+1)th layer is 0.34N+r, the length L of the positive electrode buffer coating/the negative electrode buffer coating of the (N+1)th layer is π(0.34N+r). The value of the length coefficient k is taken according to the tightness of the cell, and is in the range of 0.31-0.36, and in general, k is 0.34.

The description above shows and describes several preferred embodiments of the disclosure, but as stated above, it should be understood that the disclosure is not limited to the forms disclosed herein, and should not be considered as exclusion of other embodiments, but may be used in various other combinations, modifications and environments, and may be changed within the scope of concept of the disclosure described herein by means of the teaching or technologies or knowledge above in related fields. In addition, change and variation made by a person skilled in the art without departing from the spirit and scope of the disclosure shall belong to the scope of protection of the appended claims of the disclosure.

What is claimed is:

1. A cell, comprising: a first separator, a positive electrode plate, a second separator and a negative electrode plate, wherein the first separator, the positive electrode plate, the second separator and the negative electrode plate are stacked in sequence to form a composite electrode plate, and the composite electrode plate is wound to obtain the cell; the cell comprises a straight portion and corner portions arranged at two ends of the straight portion, and at least one surface of the positive electrode plate located at the corner portion is provided with a positive electrode buffer coating and/or at least one surface of the negative electrode plate located at the corner portion is provided with a negative electrode buffer coating.

2. The cell according to claim 1, wherein the thickness of the positive electrode buffer coating is 5-40 μm, and the thickness of the negative electrode buffer coating is 5-40 μm.

3. The cell according to claim 1, wherein the material of the positive electrode buffer coating is ethylene carbonate, and the material of the negative electrode buffer coating is ethylene carbonate.

4. The cell according to claim 1, wherein the positive electrode buffer coating is distributed in a dotted dispersion manner, and the dotted areal density is 0.1-20 mg/cm²; and the negative electrode buffer coating is distributed in a dotted dispersion manner, and the dotted areal density is 0.1-20 mg/cm².

5. The cell according to claim 1, wherein the positive electrode plate further comprises a positive current collector and a positive active coating provided on at least one surface of the positive current collector, the positive electrode buffer coating is provided on a surface of the positive active coating, and the compacted density of the positive active coating is 3.0 g/cm³-4.0 g/cm³.

6. The cell according to claim 5, wherein the positive current collector comprises a positive electrode uncoated area and a positive electrode coating area, the positive active coating is provided in the positive electrode coating area, the width of the positive electrode uncoated area is 8-15 mm, and the thickness of the positive current collector is 10-30 μm.

7. The cell according to claim 1, wherein the negative electrode plate further comprises a negative current collector and a negative active coating provided on at least one surface of the negative current collector, the negative electrode buffer coating is provided on a surface of the negative active coating, and the compacted density of the negative active coating is 1.0 g/cm³-1.8 g/cm³.

8. The cell according to claim 7, wherein the negative current collector comprises a negative electrode uncoated area and a negative electrode coating area, the negative active coating is provided in the negative electrode coating area, the width of the negative electrode uncoated area is 8-15 mm, and the thickness of the negative current collector is 2-15 μm.

9. The cell according to claim 1, wherein the corner radius of a first layer of the cell is r, the corner radius of an (N+1)th layer is kN+r, the length L of the positive electrode buffer coating/the negative electrode buffer coating of the (N+1)th layer is π(kN+r), where k is a length coefficient, and a value range of the length coefficient is 0.31-0.36.

10. The cell according to claim 1, wherein the thicknesses of the positive electrode buffer coating and the negative electrode buffer coating in different layers of the cell are different.

11. A secondary battery, comprising the cell according to claim 1.

12. The secondary battery according to claim 11, wherein the thickness of the positive electrode buffer coating is 5-40 μm, and the thickness of the negative electrode buffer coating is 5-40 μm.

13. The secondary battery according to claim 11, wherein the material of the positive electrode buffer coating is ethylene carbonate, and the material of the negative electrode buffer coating is ethylene carbonate.

14. The secondary battery according to claim 11, wherein the positive electrode buffer coating is distributed in a dotted dispersion manner, and the dotted areal density is 0.1-20 mg/cm²; and the negative electrode buffer coating is distributed in a dotted dispersion manner, and the dotted areal density is 0.1-20 mg/cm².

15. The secondary battery according to claim 11, wherein the positive electrode plate further comprises a positive current collector and a positive active coating provided on at least one surface of the positive current collector, the positive electrode buffer coating is provided on a surface of the positive active coating, and the compacted density of the positive active coating is 3.0 g/cm³-4.0 g/cm³.

16. The secondary battery according to claim 15, wherein the positive current collector comprises a positive electrode uncoated area and a positive electrode coating area, the positive active coating is provided in the positive electrode coating area, the width of the positive electrode uncoated area is 8-15 mm, and the thickness of the positive current collector is 10-30 μm.

17. The secondary battery according to claim 11, wherein the negative electrode plate further comprises a negative current collector and a negative active coating provided on at least one surface of the negative current collector, the negative electrode buffer coating is provided on a surface of the negative active coating, and the compacted density of the negative active coating is 1.0 g/cm³-1.8 g/cm³.

18. The secondary battery according to claim 17, wherein the negative current collector comprises a negative electrode uncoated area and a negative electrode coating area, the negative active coating is provided in the negative electrode coating area, the width of the negative electrode uncoated area is 8-15 mm, and the thickness of the negative current collector is 2-15 μm.

19. The secondary battery according to claim 11, wherein the corner radius of a first layer of the cell is r, the corner radius of an (N+1)th layer is kN+r, the length L of the positive electrode buffer coating/the negative electrode buffer coating of the (N+1)th layer is π(kN+r), where k is a length coefficient, and a value range of the length coefficient is 0.31-0.36.

20. The secondary battery according to claim 11, wherein the thicknesses of the positive electrode buffer coating and the negative electrode buffer coating in different layers of the cell are different.
